(19) United States
(12) Patent Application Publication
(10) Pub. No.: US 2005/0263361 A1
(43) Pub. Date: Dec. 1, 2005

(54) Spring-damper-system for a motor vehicle carriage

(76) Inventors: Achim Schulz, Niefern-Oeschelbronn (DE); Andre Stamm, Schalchen (AT)

Correspondence Address: CROWELL & MORING LLP;INTELLECTUAL PROPERTY GROUP, P.O. BOX 14300, WASHINGTON, DC, 20044-4300, US

(21) Appl. No.: 11/138,213

(22) Filed: May 27, 2005

(30) Foreign Application Priority Data
May 28, 2004 (DE) 10 2004 027 885.7

(51) Int. Cl. F16F 9/14

(52) U.S. Cl. 188/318; 188/314; 267/126; 267/64.15

(57) ABSTRACT

A spring-damper system for a motor vehicle carriage has a hydraulic master unit which supports the carriage opposite the chassis of the motor vehicle, and a hydraulic slave unit which is situated outside the carriage and is connected to the master unit via a hydraulic line. To save space, it is proposed to mount the slave unit on a bearing spring and to equip the master unit with a damping device.

This application claims the priority of German application 10 2004 027 885.7, filed May 28, 2004, the disclosure of which is expressly incorporated by reference herein.

### BACKGROUND AND SUMMARY OF THE INVENTION

This invention relates to a spring-damper system for a motor vehicle carriage including a hydraulic master unit which supports a wheel opposite a chassis of the motor vehicle, and a hydraulic slave unit which is situated outside the carriage of the motor vehicle and is connected to the master unit via a hydraulic line.

Motor vehicles are equipped with a wide variety of spring-damper systems. When they are employed in a McPherson configuration, they provide additional wheel guidance functions.

When push rod-devices are used, as known, in racing cars, for example, the bearing forces exerted on the carriage are transmitted via levers to a spring-damper system situated within the chassis.

An object of the invention is therefore to adapt the space-saving advantages found in the configuration present in racing cars for use in mass-production vehicles.

According to the invention, this object can be realized through supporting the carriage opposite the chassis via a hydraulic master unit, and by providing a hydraulic slave unit which is situated outside the carriage assembly and is connected to the master unit via a hydraulic line. The slave unit is mounted on a bearing spring, while the damping mechanism is incorporated into the master unit. An advantage of this configuration is that it creates additional space in the carriage by allowing the free placement of the voluminous bearing spring within the motor vehicle. Because the damping mechanism is integrated in the master unit, proven and economical damping means can be used. A further advantage resulting from this configuration is that the damping forces are directly exerted on the carriage without any interposition from additional elements such as hydraulic lines. If a bearing spring is used, on the other hand, hydraulic lines, which bring additional elasticity to the system, can be connected without any problems, since only a simple series connection of two springs is required, which can be incorporated without compromising design.

Advantageous embodiments of the invention are claimed.

It is proposed to supplement the bearing spring with a secondary spring. The secondary spring functions to keep the hydraulic fluid constantly pressurized during rebound of the carriage. Furthermore, the secondary spring can be connected in line to the bearing spring. In this configuration, a secondary spring of significantly lower stiffness can be used between the bearing spring and the contact surface thereof. In normal operation, that is, under static load and during spring compression, the secondary spring is fully compressed and is therefore ineffective. The secondary spring is activated, only upon complete tension release of the bearing spring, when it exerts via the slave unit a positive minimum pressure on the hydraulic fluid. Alternatively, the secondary spring can also be arranged parallel to the bearing spring. In this case it is advantageous to place the secondary spring in its own slave unit that is directly connected to either the hydraulic lines or the master unit. In this configuration, the mode of operation remains the same: In normal operation, the secondary spring is fully compressed and is activated only when the hydraulic pressure falls below a set minimum. The secondary spring is preferably realized as a steel spring or gas spring.

It is particularly advantageous if the slave unit is integrated into a fixed automobile component. In this way further weight and space-saving advantages can be realized. Long automobile components such as beams or braces are especially suited to such integration. The slave unit can be integrated into the cross beam of a suspension-subframe, so that the acoustic isolation from the chassis can thus already be realized through the location of the suspension-subframe. This additionally equates to advantages related to assembly, since the complete suspension-subframe can be preassembled with spring-damper-system and hydraulic lines. The deep placement of the slave unit in relation to the center of gravity of the vehicle is also an advantage.

Alternatively, it is possible to integrate the slave unit in a strut tower brace. Strut tower braces anchor the linkage point of the master unit on the chassis, providing reinforcement and thereby contributing to increased raw stiffness of the vehicle. The advantage of this arrangement can be found in the reduced dimensions and weight and in the short hydraulic connection between the master unit and the slave unit. Existing carriages can for the most part be used, since the slave unit is situated outside the carriage, thus allowing easy reconfiguration. Finally, the easy access to the slave units mounted up high in the front of the vehicle makes any possible maintenance easier to perform.

The master unit preferably comprises a master cylinder with pistons and a hollow piston rod, wherein the piston is equipped with conventional hydraulic damping means. It is preferable if the flow cross section of the hollow piston rod is less than half the cross section of the cylinder. The flow cross section available for the damping function is therefore greater than the flow cross section available for the master unit function.

The slave unit preferably comprises a cylinder, in which a pressure space is formed by piston movement. The piston is supported on the side opposite the pressure space by the force of a spring. The cylinder can function as a structural component of the vehicle, for example as a cross beam. Alternatively, the slave unit is comprised of a telescoping cylinder with the bearing spring wound around the outside of the telescoping portion, wherein the telescoping cylinder and the bearing spring are supported on the inside of a frame. The frame can be realized as a structural component of the vehicle, for example, a strut tower brace.

In yet another possible configuration, the slave unit comprises a telescoping cylinder, the telescoping portion of which is supported by at least one torsion spring. Two parallel torsion springs can be used, at each of the free ends of which a telescoping cylinder engages a lever, while the opposite ends of the torsion spring are clamped torque-proof In another configuration, one torsion spring is used, wherein one end is clamped torque-proof on a fixed structural component, while at the other end, the telescoping cylinder engages a lever on the torsion spring and supports itself on the fixed structural component. This solution is distinguished by compact assembly construction and easy access to components, the latter feature of which simplifies maintenance. By situating the slave unit on a suspension-subframe, a very low center of gravity can be maintained.

The various slave unit configurations described above are true for all slave units, that is, for slave units with bearing springs, for slave units with secondary springs, and for slave units with both bearing springs and secondary springs.

Embodiments of the invention are illustrated in the drawing figures.

### BRIEF DESCRIPTION OF THE DRAWINGS

FIG. 1 is a schematic view of a spring-damper system for a motor vehicle,

FIG. 2 is a primary cross section of a master unit,

FIG. 3 shows a first slave unit configuration,

FIG. 4 is a section through the slave unit shown in FIG. 3,

FIG. 5 shows a second slave unit configuration,

FIG. 6 is a section through the slave unit shown in FIG. 5, and

FIG. 7 shows a third slave unit configuration.

### DETAILED DESCRIPTION OF THE INVENTION

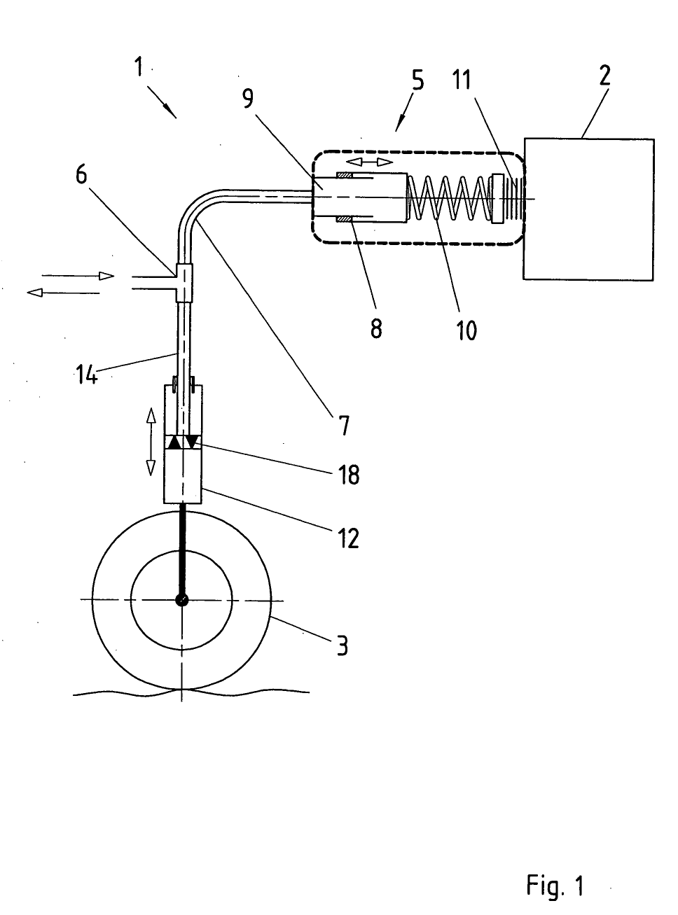

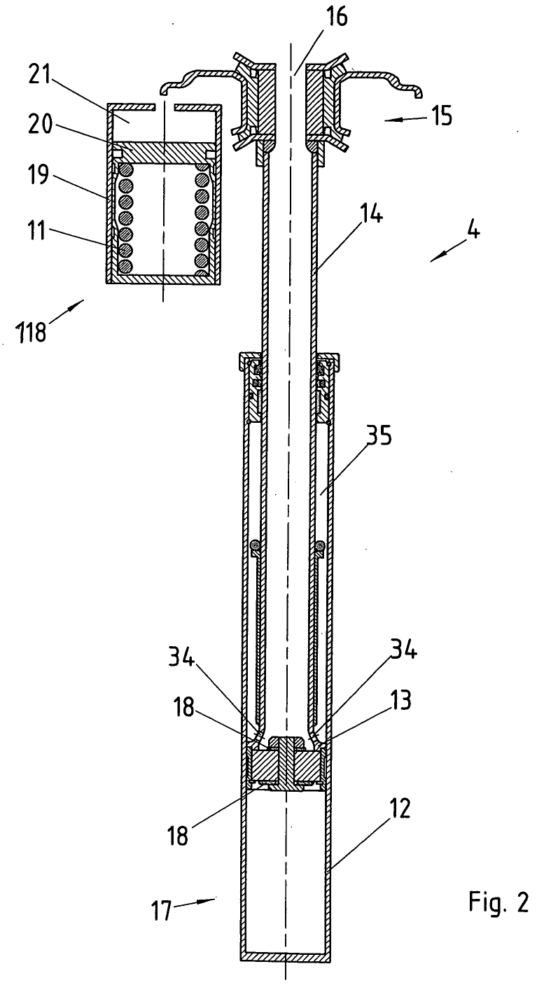

The schematic illustrations of FIGS. 1-2 show a spring-damper system 1 of a non-specified motor vehicle comprising a master unit 4 hydraulically connected to a wheel 3 and a hydraulic slave unit 5, which is attached to the chassis 2. The slave unit 5 is connected to the master unit 4 via a hydraulic line. The hydraulic line 7 is connected to a control connection 6, through which the hydraulic fluid can be fed or discharged. The hydraulic fluid volume influences, among other factors, the ground clearance of the vehicle.

In the hydraulic slave unit 5 a pressure space 9 is formed in a telescoping cylinder 8, connected to the hydraulic line 7, and filled with hydraulic fluid. The telescoping cylinder 8 is supported by a bearing spring 10 in a closed frame, wherein the bearing spring 10 is situated in such a way that it can absorb the bearing force absorbed by the master unit 4 when the vehicle 1 is operated. In line with the bearing spring 10 is a secondary spring 11. The spring stiffness of the secondary spring 11 is set so that it is fully compressed during normal operation, that is, during static load and during compression.

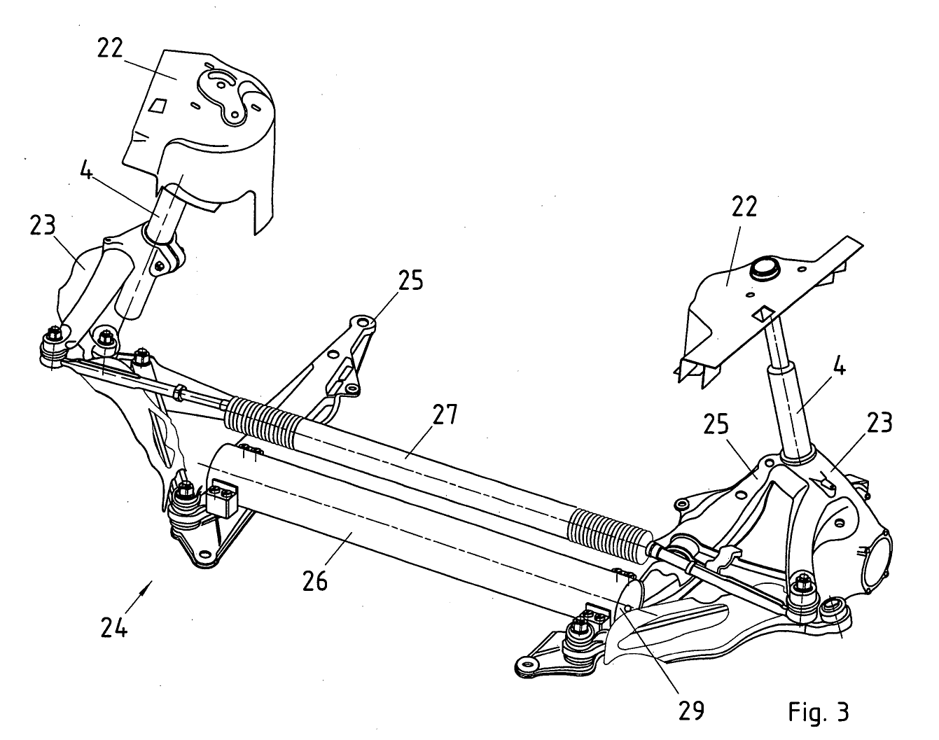

FIG. 2 shows a main section of the master unit 4. The master unit 4 comprises a cylinder 12, a piston 13 introduced therein and a hollow piston rod 14 connected to the piston. The piston rod 14 is equipped at one end with a bearing retainer 15 and an adaptor 16 for the hydraulic line 7. The opposite end 17 of the master unit 4 is clamped on a wheelmount 23 (see FIG. 3) as is standard for a McPherson axle.

The piston 13 is equipped with damping devices 18, which are illustrated here as a directionally sensitive restrictors. When the piston 13 moves back and forth in the cylinder 12, the corresponding volume is thereby compressed or expanded in the cross section of the piston rod 14, resulting in the hydraulic volume stream through the hollow piston rod 14 and hydraulic line 7 into the slave unit 5. Because the piston 13 is funnel-shaped, bypass drill holes 34 are present, through which the portion of the hydraulic fluid that did not flow out via the hollow piston rod can be absorbed into an upper chamber 35 of the cylinder 12. The hydraulic volume stream through the hollow piston rod 14 is activated in the slave unit 5 in the pressure chamber 9 and exerts pressure via the telescoping cylinder 8, thereby changing the length of the bearing spring 10. As a result the force exerted by the bearing spring 10 on the telescoping cylinder 8 changes. This in turn results in a change in hydraulic fluid pressure, which builds up a force at the master unit 4 through the cross sectional area of the piston rod 14. The force becomes effective as a bearing force between the bearing retainer 15 and the clamped end 17 of the master unit 4 and therefore between the wheel 3 and the chassis 2.

FIG. 2 shows an alternative configuration of the slave unit 5, in which the secondary spring 11 is present in an additional second slave unit 118. In this example the second slave unit 118 is mounted directly next to the master unit 4 and comprises a cylinder 19 and a piston 20 introduced therein, which defines a pressure space 21 opposite the secondary spring 11. The pressure space 21 is connected to the hydraulic line 7. The first slave unit 5 can also be illustrated in this way.

FIG. 3 shows a first option for situating the slave unit 5 (FIG. 1) in a motor vehicle. The spring-damper-system is shown in McPherson-configuration, that is, wherein the master unit 4 assumes guidance functions for the wheel 3. While the master units are integrated directly in strut towers 22 of the chassis 2 and thereby support the wheelmount 23, further elements of the carriage are mounted on a suspension-subframe 24, which is elastically supported opposite the chassis 2. The suspension-subframe 24 is comprised of two longitudinal chassis beams 25 as well as a cross beam 26. A steering drive 27 is further mounted on a cross beam 26.

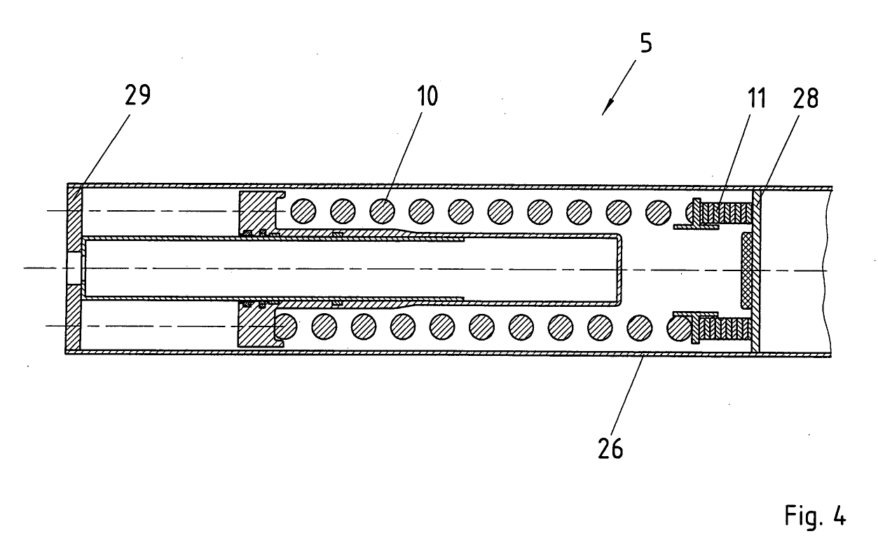

The cross beam 26 serves as a housing for two slave units 5, with a corresponding slave unit 5 present for each master unit 4. Only one slave unit 5 is illustrated in FIG. 4. Within the cross beam 26, the telescoping cylinder 8 is supported on the bearing spring 10 with the secondary spring 11 being mounted in line behind the bearing spring 10. The secondary spring 11 is situated on a separating plate 28 mounted in the middle of the cross beam 26. The telescoping cylinder 8 is supported on a seal plate 29 of the cross beam 26 and is connected to the corresponding master unit 4 via the hydraulic line 7 (not illustrated).

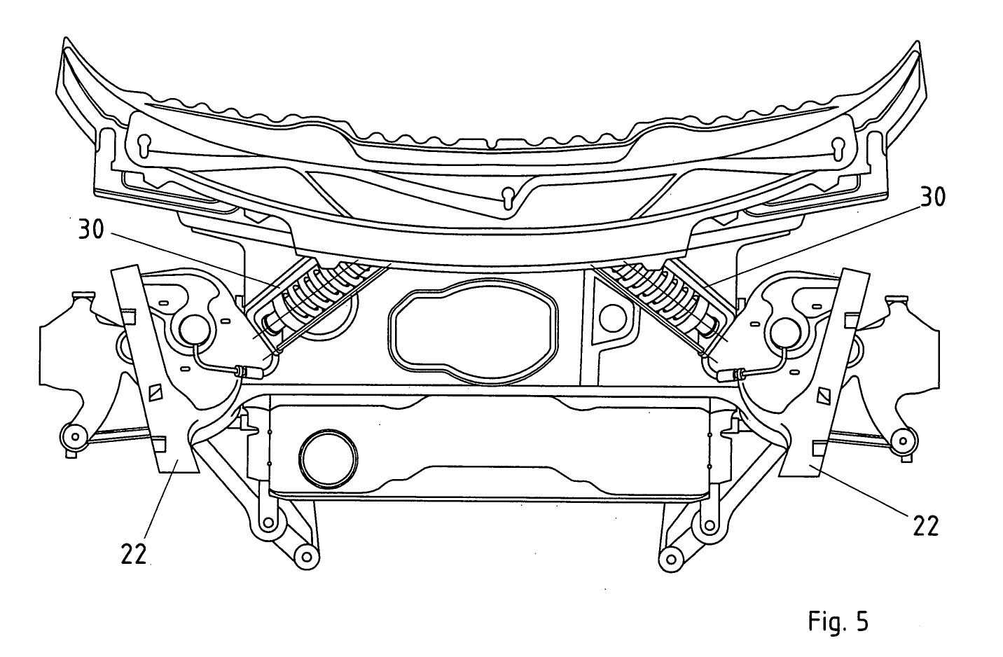

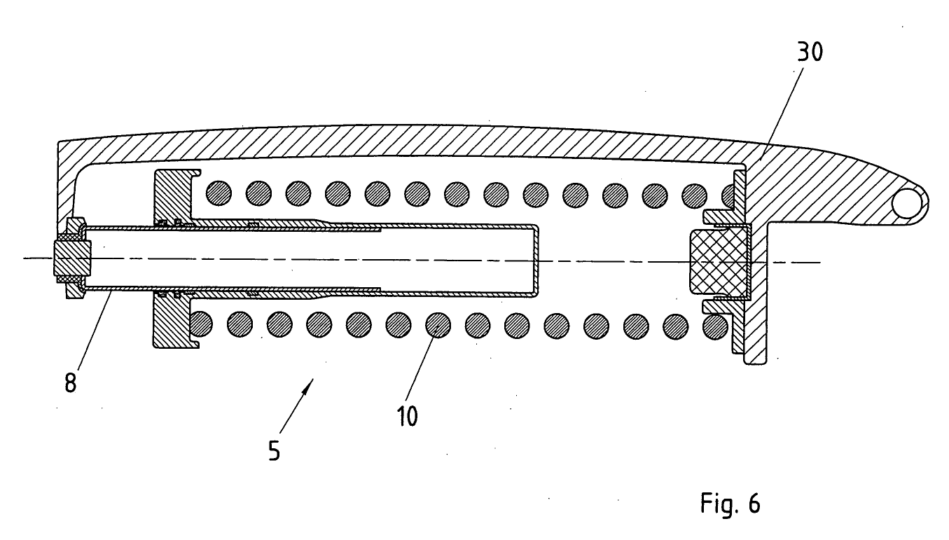

FIG. 5 is a bird's-eye-view of a second option for configuring the slave unit 5. The strut towers 22 are supported by the strut tower braces. Each of the strut tower braces 30 integrates one slave unit 5. In the illustrated slave units 5, the bearing springs 10 are retained outside the telescoping cylinders (see FIG. 6). The strut tower brace 30 is constructed as a frame for anchoring the telescoping cylinder 8 and the bearing spring 10. The hydraulic lines 7 between the master units 4 and the corresponding slave units 5 are not illustrated.

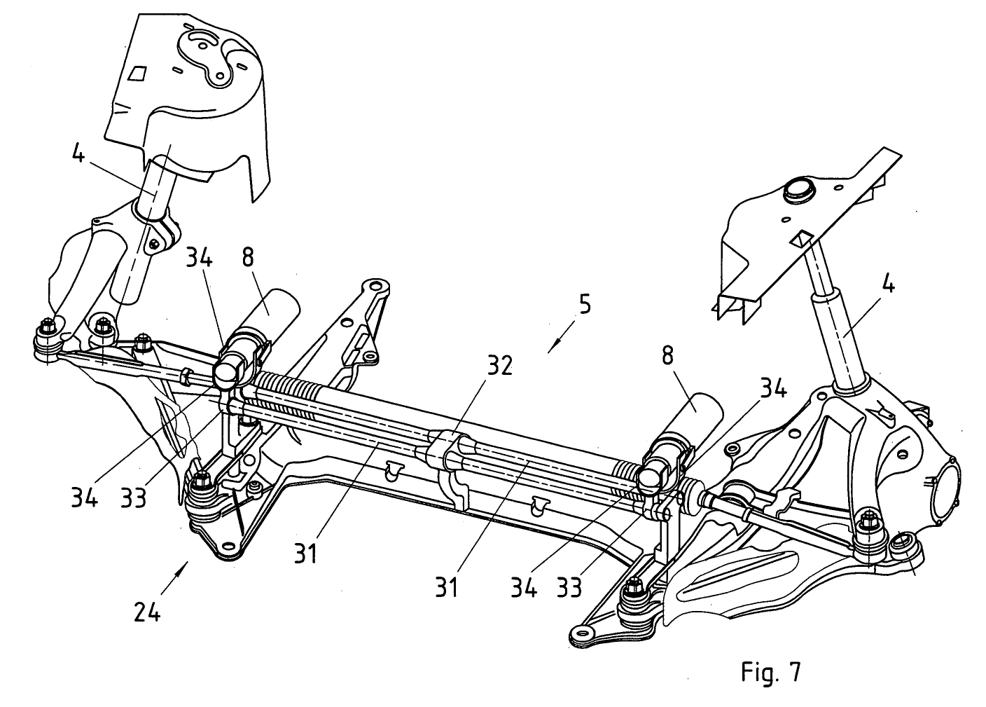

FIG. 7 shows a third option for configuring the slave unit 5, which can be employed even with a McPherson chassis frame. A suspension subframe 24—illustrated here as one piece—has two parallel torsion springs 31, which are clamped torque-proof concentrically in a trestle 32. The free ends 33 of the torsion springs 31 are connected via a lever 34 with telescoping cylinders 8 in such a way that a movement in one of the telescoping cylinders 8 leads to a deviation of the torsion springs 31 in the opposite direction. In this configuration, the torsion springs 31 assume the function of the bearing spring 10 and, together with the levers 34 and the telescoping cylinder 8, constitute the slave units 5. The hydraulic lines 7 between the master units 4 and the corresponding telescoping cylinders 24 are not illustrated.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A spring-damper system for a carriage of a motor vehicle, comprising:
a hydraulic master unit which supports a wheel opposite a chassis of the motor vehicle,
a hydraulic slave unit which is situated outside the carriage of the motor vehicle and is connected to the master unit via a hydraulic line,
a bearing spring by which the slave unit is supported, and
a damping mechanism with which the master unit is equipped.

2. The spring-damper system as claimed in claim 1, and further comprising a secondary spring in addition to the bearing spring.

3. The spring-damper-system as claimed in claim 2, wherein the secondary spring is arranged in line with the bearing spring.

4. The spring-damper system as claimed in claim 2, wherein the secondary spring is parallel to the bearing spring.

5. The spring-damper system as claimed in claim 4, wherein the secondary spring exerts force on a hydraulic fluid and is connected to the master unit or the hydraulic line.

6. The spring-damper system as claimed in claim 1, wherein the slave unit is integrated into a fixed structural component of the motor vehicle.

7. The spring-damper system as claimed in claim 6, wherein the fixed structural component is a beam.

8. The spring-damper system as claimed in claim 6, wherein the fixed structural component is a brace.

9. The spring-damper system as claimed in claim 1, wherein the master unit comprises a cylinder, in which a piston and hollow piston rod connected to the piston are introduced, and wherein the piston is equipped with a hydraulic damping device.

10. The spring-damper system as claimed in claim 9, wherein a stream cross section of the hollow piston rod is less than half the cross section of the cylinder.

11. The spring-damper system as claimed in claim 9, wherein the slave unit includes a cylinder in which a pressure space is formed by the movement of the piston, and wherein the piston is supported on a side opposite the pressure space by another spring.

12. The spring-damper system as claimed in claim 1, wherein the slave unit includes a telescoping cylinder having an outside around which the bearing spring is wound, and wherein the telescoping cylinder and the bearing spring are supported by an inside of a frame.

13. The spring-damper system as claimed in claim 1, wherein the slave unit includes a telescoping cylinder which is supported by at least one torsion spring.

14. The spring-damper system as claimed in claim 2, wherein the slave unit is integrated into a fixed structural component of the motor vehicle.

15. The spring-damper system as claimed in claim 2, wherein the master unit comprises a cylinder, in which a piston and hollow piston rod connected to the piston are introduced, and wherein the piston is equipped with a hydraulic damping device.

16. The spring-damper system as claimed in claim 2, wherein the slave unit includes a telescoping cylinder having an outside around which the bearing spring is wound, and wherein the telescoping cylinder and the bearing spring are supported by an inside of a frame.

17. The spring-damper system as claimed in claim 2, wherein the slave unit includes a telescoping cylinder which is supported by at least one torsion spring.

18. The spring-damper system as claimed in claim 14, wherein the fixed structural component is a beam.

19. The spring-damper system as claimed in claim 14, wherein the fixed structural component is a brace.

20. The spring-damper system as claimed in claim 15, wherein a stream cross section of the hollow piston rod is less than half the cross section of the cylinder.
